(19) United States
(12) Patent Application Publication
(10) Pub. No.: US 2025/0265056 A1
(43) Pub. Date: Aug. 21, 2025

(54) SYSTEMS, METHODS, AND COMPUTER-READABLE MEDIA FOR THINNING BLOATED CONTAINERS

(71) Applicants: Kiran Kamity, San Jose, CA (US); Naman Tandon, Bangalore (IN); Michael Kevin Larkin, South Tahoe, CA (US)

(72) Inventors: Kiran Kamity, San Jose, CA (US); Naman Tandon, Bangalore (IN); Michael Kevin Larkin, South Tahoe, CA (US)

(73) Assignee: Cisco Technology, Inc., San Jose, CA (US)

(21) Appl. No.: 19/052,413

(22) Filed: Feb. 13, 2025

Related U.S. Application Data
(60) Provisional application No. 63/553,730, filed on Feb. 15, 2024.

(51) Int. Cl. G06F 8/41

(52) U.S. Cl. CPC G06F 8/433

(57) ABSTRACT

Systems, methods, and computer-readable media for thinning bloated containers are described herein. A thinning module may identify one or more dependencies of a container that are not needed by application and can cause the one or more identified dependencies to be removed. In some embodiments, the thinning module can generate a script that removes the identified one or more dependencies from the container to produce a thinned container. The thinned container can then be used by an application that employs that container. The script can be generated for commonly used containers that are used across an organization. Recommendations to use commercially available containers in lieu of a thinned container can be made to users in charge of maintaining containers being used by applications in their organization.

### CROSS-REFERENCE TO A RELATED APPLICATION

This application claims priority to U.S. Provisional Patent Application No. 63/553,730, filed Feb. 15, 2024, the disclosure of which is incorporated by reference in its entirety.

### TECHNICAL FIELD

This disclosure relates to systems, methods, and computer-readable media for a container management, and more particularly, to intelligent thinning of containers.

### BACKGROUND

Applications can run in isolated packages of code called containers. Containers can include all the dependencies an application may need to run on a host operating system, such as libraries, binaries, configuration files, and frameworks, into a single executable. Over time, containers can become bloated with dependencies that are not used, no longer function, or compromised. Such dependencies may potentially become a source of issues for the application.

Accordingly, what is needed is an efficient and practical way to remove select dependencies to thin the container for an application.

### SUMMARY

Systems, methods, and computer-readable media for intelligently thinning containers are provided. Embodiments discussed herein can determine how a container image is built and can recommend running a custom made script designed to remove dependencies identified as no longer being suitable for use by the container image. When the script is run, it can remove the identified dependencies. After the script is run, the thinned container image may be more amenable to efficient analyzation thereof because it does not commit resources and computational cycles to any of the identified dependencies.

This Summary is provided to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The above and other aspects of the disclosure, its nature, and various features will become more apparent upon consideration of the following detailed description, taken in conjunction with the accompanying drawings, in which like reference characters may refer to like parts throughout, and in which:

FIG. 1 shows a schematic diagram of an example computer or server in accordance with an embodiment.

FIG. 2 shows a conventional flow of API calls originating from an application in a generic software stack.

FIG. 3 shows a flow diagram for intercepting calls at the API/library level according to an embodiment.

FIG. 4 shows an illustrative block diagram of how the application calls are intercepted, how event telemetry is collected, and how the application calls are executed according to an embodiment.

FIG. 5 shows an illustrative block diagram of an integrated loader according to an embodiment.

FIG. 6 shows an illustrative block diagram of an instrumentation module or system loading module according to an embodiment.

FIG. 7 shows an illustrative block diagram of a portal according to an embodiment.

FIG. 8 shows an illustrative block diagram of a thinning module in connection with an application or software product being observed or analyzed by observation or runtime analytics software, according to an embodiment.

FIG. 9 shows an illustrative process for a thinning a container according to an embodiment.

### DETAILED DESCRIPTION

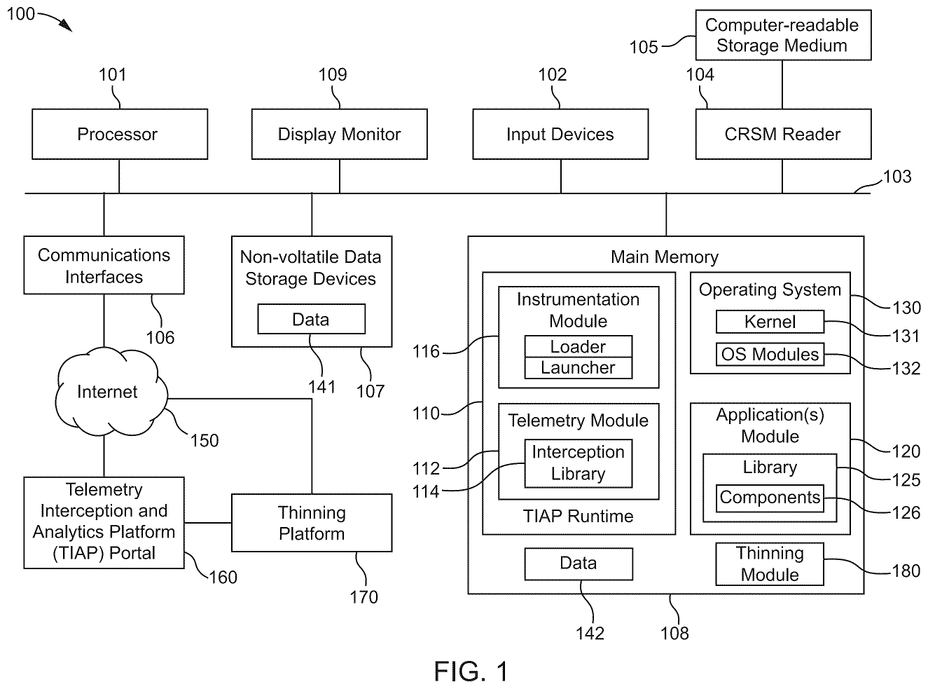

Systems, methods, and computer-readable media for are provided and described with reference to FIGS. 1-9. Intelligent container thinning can operate in conjunction with a telemetry interception and analysis platform are discussed herein.

Modern applications can be deployed in containers (e.g., Docker containers) to assist with dependency management, packaging, and deployment concerns. Containers allow a developer to package all required dependencies with the application, so that there is less risk when deploying the application in alternate environments. Packaging dependencies with the application ensures that if incompatible libraries are found on the system where the application is being deployed, only the approved/certified libraries are loaded. Packaging applications this way also provides the capability for different versions of the same dependency to be simultaneously used by different applications.

When applications are packaged in containers, a container image is typically created at the time the application is built. This container image is published to a container registry, which allows end users and/or customers to download that image and create a local instance of that container image, which contains all the dependencies required for the application to run.

An application may include multiple containers that work together in concert to provide the functionality of the entire application as a whole. When containers are deployed in a customer/user's environment, it is possible that many containers can be simultaneously running, as required by the application. For some organizations, many of the same containers may be shared across different applications.

Container orchestration is a term that refers to the management of containers on a host (virtual machine or physical machine). Since there may be many containers running, it is important to limit the resources consumed by any single container, so that sufficient resources are available to run all the required containers. Containers that exceed their resource limits might be terminated by the container orchestration software.

Further, containers may need to be replicated (or scaled) if the application load becomes too great. For example, a container orchestration software may periodically monitor the performance of a database container, and if database queries are taking too long to complete, it may choose to start a second (or third, etc.) instance of that database container on a host to load balance. The container orchestration software is typically responsible for acting as a network intermediary in this scenario, to provide the round-robin load balancing characteristics. Containers scaled in this way may be started on the same host or a different host, based on available host resources. A commonly used container orchestration platform is Kubernetes (K8s). Kubernetes provide orchestration capabilities for containers (which K8s refer to as ‘pods’), providing resource management, resource limiting, scheduling, scaling (replicating) pods, and the network fabric between pods.

Containers may become bloated with various dependencies that are not used by the application, should not be used by the application, are expired, identified as being vulnerable (e.g., by a common vulnerability and exposure), or are associated with some other issue that can potentially an issue for the application. Container bloat is a common problem in the software industry. Container bloat can decrease efficiency of applications. In some cases, container bloat can result in a failed operation of an application or result in a security breach.

Embodiments discussed herein refer to a container thinning module that can identify dependencies that are not needed in the container and provide recommendations to remove said dependencies or generate a scrip that removes the identified dependencies from the container to produce a thinned container for use by the application. This container thinning module may be used in conjunction with software products that offer observability or runtime analysis. These software products might include security products, performance monitoring products, network analytics products, and so on. As a specific example, the thinning module may operate with a telemetry interception and analysis platform (TIAP), which is briefly discussed below and also described in applicant's commonly owned U.S. Pat. Nos. 11,151,009, 11,0366,606, and 11,243,861, the disclosures of which are incorporated by reference herein in their entireties. Embodiments discussed herein provide several advantages over the existing state of the art. For example, the container thinning module understands with high specificity exactly how each container is built. That is, through collaboration with the TIAP, every dependency is identified and applied to a set of filters to identify dependencies that can be removed from the container. The filters can include any number of filters to determine whether a dependency can be removed. For example, one filter may determine whether a dependency is used by the application. If a dependency is identified as not being used, that dependency may be earmarked for removal. As another example, another filter can identify dependencies that are considered bad, corrupt, outdated, or subject to known vulnerabilities. Such dependencies may also be earmarked for removal.

In one embodiment, after dependencies associated with a container are identified for removal, a script may be generated to automatically remove the identified dependencies from the container. In yet another example, if the container is one that is used across multiple applications for an organization, for example, the script may be applied to each container associated with the multiple applications to remove the identified dependencies. This way, a container that is commonly used across applications (e.g., for different products or features) for an organization is uniformly thinned across the organization.

In yet another embodiment, after dependencies associated with a container are identified for removal, a recommendation module can evaluate the contents of the container based on an assumption that it has or will be thinned and compare the thinned container to a library of commercially available containers. If the thinned container meets criteria to be replaced by at least one of the commercially available containers, the recommendation module can provide a recommendation to a user that a viable commercial container is available as an alternative to the thinned container. Use of the commercial container may be desirable from an operations perspective because the user will not have to maintain its container but can rely on the third supplier of the commercial container to do the required maintenance.

As defined herein, an alert is an abnormal condition that has been identified by an analytics service, based on a rule defined in an alert grammar.

As defined herein, an alert grammar includes a set of rules or parameters that are used to classify telemetry events obtained by a telemetry interception and analysis platform (TIAP) during operation of an application. The set of rules can be part of default set of rules provided by the TIAP, generated by a customer using the TIAP, heuristically learned rules created by machine learning, or any combination thereof. Other grammars may be used by the TIAP such as, for example, insight grammars, performance grammars, and warning grammars. Yet other grammars can include compliance grammars that search telemetry data for specific items such as, for example, credit card numbers, personally identifiable information (PII), addresses, bank accounts, etc.

As defined herein, an analytics service refers to one of many services handled by the TIAP and operative to perform analytics and telemetry events collected from an application. The analytics service may reference an alert grammar, insight grammar, performance grammar, or any other grammar to evaluate collected telemetry events.

As defined herein, an application refers to a top hierarchy level of monitoring by the TIAP. An application includes one or more component groups and represents a complete implementation of a top-line business application.

As defined herein, an API Server is a service that implements endpoint APIs (REST-based) for use by user interface (UI) and command line interface (CLI) tools.

As defined herein, a blueprint service analyzes recorded telemetries for one or more components and creates alert rules based on what has been seen. The blueprint service can be used to define behavioral blueprints that describe the intended behavior of an application (e.g., how an application should be behave, what it should do, and what it should not do).

As defined herein, a component is abstract definition of a single type of process known to the platform (e.g., “database” or “web server”). An application can operate using one or more components.

As defined herein, a component instance is an individual concrete example of a component, running on a specific host or a virtual machine (e.g., “database running on myserver.corp.com”). One or more instances may occur for each component.

As defined herein, a container is a standard unit of software that packages up code and all its dependencies so the application can run quickly and reliably from one computer environment to another. Sometimes, a container is referred to as a pod.

As defined herein, a bloated container can include one or more dependencies that can be removed from a container.

As defined herein, a thinned container can be a bloated container that has had one or more dependencies removed or earmarked from removal.

As defined herein, a component group is a collection of all instances of a given component (e.g., “all databases in application x”).

As defined herein, a common vulnerability and exposure (CVE) is a system that provides a reference-method for publicly known information-security vulnerabilities and exposures. The National Cybersecurity FFRDC, operated by the Mitre Corporation, maintains the system, with funding from the National Cyber Security Division of the United States Department of Homeland Security. The system was officially launched for the public in September 1999. The Security Content Automation Protocol uses CVE, and CVE IDs are listed on MITRE's system as well as in the US National Vulnerability Database.

As defined herein, a CVE service is a platform service that periodically ingests CVE metadata and analyzes if any components are vulnerable to any known CVEs.

As defined herein, a dashboard can refer to a main screen of a TIAP portal UI.

As defined herein, a dependency is a component that is included as part of a container and may or may not be used by an application when the container is executed.

As defined herein, an event service is a service that responds to telemetry event submissions using a remote call (e.g., gRPC or representational state transfer (REST)) and stores those events in an events database.

As defined herein, a housekeeping service is a service that periodically removes old data from logs and databases.

As defined herein, an identified dependency refers to a dependency included in a container that meets criteria to be removed from the container.

As defined herein, an insight is a noncritical condition that has been identified by the analytics service, based on a rule defined in a grammar. Insights are typically suggestions on how performance or other software metrics can be improved, based on observed telemetries.

As defined herein, Kubernetes refers to an open-source orchestration system for automating software deployments, scaling, and management.

As defined herein, a native library refers to a collection of components or code modules that are accessed by the application.

As defined herein, an interception library is created by the TIAP and is used to intercept API calls by the application and record the API calls as a telemetry event. The interception library can trampoline the original API call to the native library. The interception library can include the same functions of the native library or subset thereof and any proprietary APIs, but is associated with analysis platform and enables extraction of telemetry events related to operation of the application. When a function is called in the interception library, the telemetry event collection is performed and actual code in the native library is accessed to implement the function call.

As defined herein, a TIAP portal may refer to a Software as a Service (SaaS) or on-premise management server that host TIAP, including the dashboard and other TIAP UI screens, as well as any services required to set up installation of TIAP runtime code to monitor a customer's application, collect telemetry from the customer's application, and analyze collected telemetry.

As defined herein, a metric can refer to telemetry data collected that includes a numeric value that can be tracked over time (to form a trend).

As defined herein, a policy may be a security ruleset delivered to the runtime during initial communication/startup that describes desired tasks that are to occur when certain events are detected (e.g., block/allow/warn).

As defined herein, TIAP runtime or Runtime refers to a code module that runs within a loaded process' (component instance) address space and provides TIAP services (e.g., telemetry gathering, block actions, etc.).

As defined herein, a system loader is software tool that combines a customer's executable code with the runtime code to produce a binary output that is then used in place of the original executable code.

As defined herein, a trampoline or trampoline function is a runtime internal technique of hooking/intercepting API/library calls used by a component.

As defined herein, a trend is a change of metric values over time.

As defined herein, a vulnerability report associates a known vulnerability (e.g., a CVE) with a function, module, or object called by an application.

As defined herein, a warning is an abnormal condition that may not be critical, that has been detected by the analytics service, based on a rule defined in an alert/insight/warning grammar.

FIG. 1 shows a schematic diagram of an example computer or server in accordance with an embodiment. The computer or server of FIG. 1 may have fewer or more components to meet the needs of a particular application. As shown in FIG. 1, the computer may include a processor 101. The computer may have one or more buses 103 coupling its various components. The computer may include one or more input devices 102 (e.g., keyboard, mouse), a computer-readable storage medium (CRSM) 105 (e.g., floppy disk, CD-ROM), a CRSM reader 104 (e.g., floppy drive, CD-ROM drive), a display monitor 109 (e.g., cathode ray tube, flat panel display), communications interfaces 106 (e.g., network adapters, modems) for communicating over computer networks, one or more non-volatile data storage devices 107 (e.g., hard disk drive, optical drive, FLASH memory), and a main memory 108 (e.g., RAM). Software embodiments may be stored in a computer-readable storage medium 105 for reading into a non-volatile data storage device 107 or main memory 108. Data may be stored in data storage device 107 as data 141 or memory 108 as data 142. Software embodiments may also be received over a network, such as Internet 150 by way of a communications interface 106. In the example of FIG. 1, main memory 108 includes many different software modules. Note that these software modules may also run in data storage locations other than main memory.

The operating system 130 may include a UNIX-like operating system, such as the Linux operating system, iOS operating system, Mac OSX operating, or Windows operating system. Operating system 130 can include a kernel 131 and operating system modules 132. Operating system modules 132 can include components of operating system 130 other than kernel 131.

Other modules can include TIAP runtime module 110, telemetry module 112, instrumentation module 116, and applications module 120. Application module 120 may include computer-readable code for executing an application running on computer 100. The code may include executable code (e.g., a .exe file). Application module 120 may include a native library 125 (e.g., Libc.so) that is used during operation of the application. Native library 125 may include one or more components 126.

TIAP runtime module 110 may include computer readable code for executing operation of telemetry module 112 and instrumentation module 116, referred to herein as TIAP runtime or TIAP runtime code. TIAP runtime module 110 may include the TIAP runtime operative to collect telemetry events and provide the collected telemetry events to TIAP portal 160 via Internet 150.

Telemetry module 112 can include computer-readable code that is operative to intercept application programming interface (API) calls originating from the application at the library level within the software stack and capture such calls as telemetry events that are provided to TIAP 160 for further analysis. Telemetry module 112 may include an interception library 114. Interception library 114 may include interception code and trampoline functions corresponding to each component or API called by the application. The TIAP runtime can interpose on any function in any library used by any component by inserting interception hooks or trampoline functions into the application's dependency chain (e.g., IAT/PLT/GOT). These trampoline functions redirect control flow from the native library API functions to the TIAP runtime, which then collects information about the API request (parameters, call stack information, performance metrics, etc.) as telemetry events, and then passes the original call to the native library. The interception code is responsible for collecting the parameters needed for the telemetry event. Telemetry events can be continually monitored by the TIAP runtime. Each component instance is continually monitored by the TIAP runtime and the desired telemetry events are captured and sent to TIAP portal 160 Telemetry events can be collected into batches and periodically sent to the TIAP portal for later analysis. The batching capability of the platform runtime can be further subdivided into prioritized batches—this entails creating multiple event queues that are sent with varying priorities to TIAP portal 160. This subdivision is useful in scenarios where the runtime is only allotted a small amount of CPU/memory/network bandwidth (as to not interfere with efficient application execution). In the case where events may be dropped (due to not having sufficient resources), the TIAP runtime can instead collect a count of “missed events” that can be later communicated to the management platform when resources are available. This count provides the system administrator with a sense of how many events may be missing from the overall report provided by TIAP portal 160.

Instrumentation module 116 may be operative to load or package the necessary files and/or library associated with an application with files and/or library associate with platform 118 into a loader, launcher, or executable file that enables telemetry module 112 to extract telemetry events from the application during TIAP runtime.

TIAP portal 160 may perform analytics on the collected telemetry events and generate visuals for display to users of computer 100 based on the analytics obtained from the analysis of the application.

Thinning platform 170 may enable a user to define how a container can be thinned according to embodiments discussed herein. Thinning platform 170 may be integrated with or communicate with TIAP portal 160 or it can run independently thereof and can communicate with an application via Internet 150. In some embodiments, platform 170 may provide a user interface that enables a user to define filters for identifying dependencies that that can be removed from a bloated container. In addition, in another embodiment, platform 170 can enable a user to define criteria for recommending commercially available containers that functionally resemble a thinned container. If desired, the user interface for thinning platform 170 may be included as part of the user interface with TIAP portal 160.

Thinning module 180 may be responsible for identifying dependencies in a bloated container that can be removed from the container or earmarked for removal from the container. Thinning module 180 may also generate a script that can be run by a user to remove the identified dependencies from the bloated container or from a bloated container that is commonly shared among several different applications within an organization. Thinning module may also assess whether a thinned container can be replaced with a commercially available container that is functionally the same.

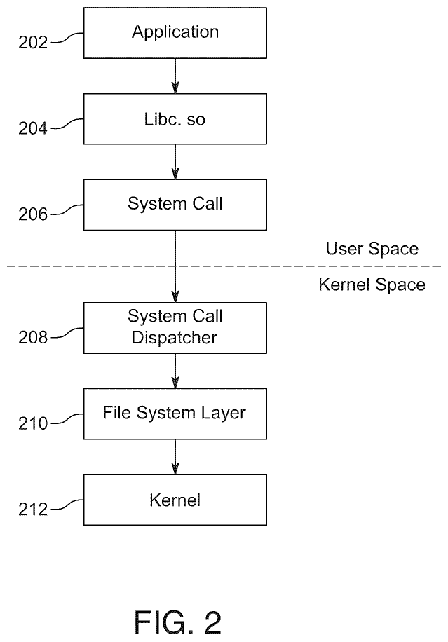

FIG. 2 shows a conventional flow of API calls originating from an application in a generic software stack. System memory in UNIX-like operating systems may be divided into two distinct regions, namely kernel space and user space. FIG. 2 shows the user space and the kernel space demarcated by the dashed line. Kernel space is where the kernel executes and provides its services. User space is where a user process (i.e., all processes other than the kernel) executes, a process being an instance of an executing program. The kernel manages individual user processes within the user space and prevents them from interfering with each other. A user process typically cannot access kernel space or another user process's user space. However, an active user process may access kernel space by invoking a system call.

Starting with block 202, an application can make an application programming interface (API) call (e.g., open, write, read, etc.). That call is passed to block 204 where a library (e.g., Libc.so) is accessed to execute the API call. The library can contain subroutines for performing system calls or other functions. At block 206, a system call is invoked. The system call may be a modification of an existing system call generally available from the operating system. For example, the system call may be a modified version of the ioctl system call. The system call may be invoked by filling up register values then asserting a software interrupt that allows trapping into kernel space. For example, block 206 may be performed by a C language program that runs in the Linux operating system. The C language program may move the system call's number into the register of a processor and then assert an interrupt. The invocation of the system call can be made using a programming language's library system call interface. In one embodiment, the invocation of the system call is made using the C programming language's library system call interface.

In block 208, the invocation of the system call executes a trap to enter the kernel space. The system call dispatcher gets the system call number to identify the system call that needs to be invoked.

In block 210, the system call dispatcher vectors branches to the system call, which in the example of FIG. 2 involves a file operation. Accordingly, the system call is executed through the operating system's file system layer. The file system layer may be the Virtual File System (VFS) layer of the Linux operating system, for example. During blocks 208 and 210, the kernel stack gets populated with information that allows the processor to execute the instructions relating to the system call. Such information may include the return address of the system call and the system call table address. In block 212, the system call invoked in block 206 is executed in the kernel.

The TIAP is purpose-built to automatically observe cloud native applications, employing a language-agnostic library that can be deployed to any Kubernetes cluster with a single command-no sidecars, agents, or kernel modules required. By correlating static container scans with runtime analysis, the TIAP enables developers to resolve issues faster with rich remediation guidance.

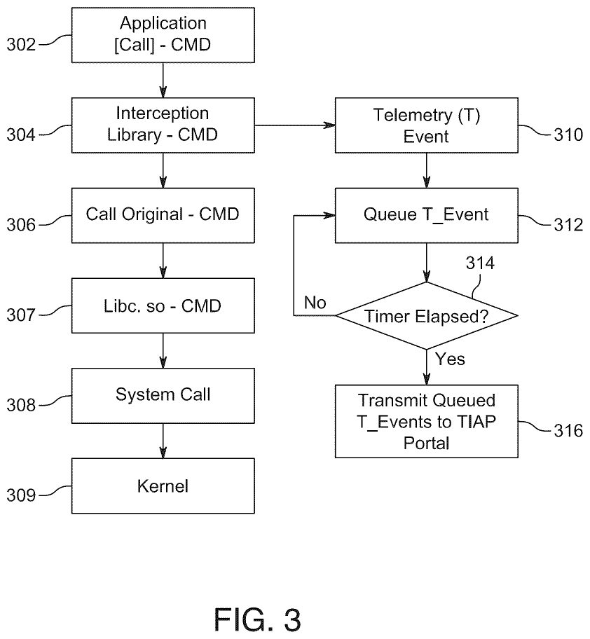

The TIAP according to embodiments discussed herein can intercept operations originating from the application at the library level of the software stack. This is in contrast with conventional hook operations that intercept at the system call level or somewhere within the kernel space, typically accessed using Extended Berkeley Packet Filter (eBPF). Hooks using eBPF are often subject to various issues such as software updates to parts of the software stack that require special permissions, administrator permissions, or lack of API assurance that can result in breaking the application. Therefore, to eliminate such issues, embodiments discussed herein intercept at the library level. Referring now to FIG. 3, a flow diagram for intercepting calls at the API/library level according to embodiments discussed herein is shown. Starting at block 302, an application makes an API call to execute a particular command (shown as CMD). The command is passed to an interception library at block 304. The interception library is interposed between the application call and the native library associated with the application (block 308). The application is programmed via an instrumentation or system loading process (e.g., performed by instrumentation module 116) to interact with the interception library first before calling the original command with the native application.

The interception library can include the same functions of the native library or subset thereof and any proprietary APIs, but is associated with analysis platform and enables extraction of telemetry events related to operation of the application. When a function is called in the interception library, the telemetry event collection is performed and actual code in the native library is accessed to implement the function call. Telemetry events are shown in block 310. The interception library can enable all parameters of the API call to be recorded in a telemetry event. For example, if the API call is an OPEN command, the parameters can include file path, permissions, identification information, environmental information, etc. Since applications are continually monitored using embodiments discussed herein, telemetry events are constantly being collected and provided to the TIAP portal (e.g., portal 160). For example, the telemetry events may be queued at block 312 and batch transmitted to the analysis platform (block 316) each time a timer elapses at decision block 314. The TIAP portal can be run locally on the same device that is running the application or the analysis platform can be run remotely from the device running the application. In the remote case, the telemetry events may be transmitted via a network connection (e.g., the Internet) to the TIAP portal.

Telemetry events collected by the TIAP runtime can be buffered in memory into a lock-free queue. This requires little overhead during loaded program execution as the telemetry upload occurs less frequently. The size of the event queue is determined by a setting periodically refreshed by the TIAP portal. The customer is permitted to set the amount of memory and CPU overhead that the TIAP runtime can consume. The TAP runtime can adjust the size of the event queue and the quality of data measured accordingly. In the case that events need to be dropped due to exceeding the allowed CPU/memory thresholds, a simple counter can be maintained to reflect the number of dropped events. When there are adequate resources available, the number of missed events is communicated to the TIAP platform. The buffer can be flushed periodically, depending on size and overhead constraints. This is done at event submission time (e.g., any event can potentially trigger a buffer flush). During flush, the events in the queue are batched and sent to an event service in the TIAP portal using REST or gRPC. The TIAP runtime can also support a high-priority queue for urgent events/alerts.

The TIAP runtime may be required to handle special cases. The special cases can include handling signals, handling dynamic library loads, and handling fork and exec functions. Signal handling is now discussed. Telemetry events occurring during signal handling have to be queued in a way that uses no signal-unsafe APIs; this is the exception to the rule that that any event can cause a buffer flush. All trappable signals are caught by the runtime. The runtime increments a counter of received signals for periodic upload to the management portal. In order to support the component's own use of signals, the runtime retains a list of any handlers the component registers using sigaction and invokes those handlers upon receiving a signal. This may require removing a stack frame before calling the handler.

The runtime intercepts calls to the dlsym, dlopen, and other dynamic library load routines. These loaded libraries are subject to the same telemetry grammar treatment as during initial load. Calls to these functions also may result in telemetry events of their own.

The fork and exec functions require special treatment. Fork can result in an exact copy of the process being created, including a TIAP runtime state. In order to support fork properly, the fork call is intercepted and the following sequence of operations is performed: a fork telemetry event is sent (if such a telemetry grammar exists), the child's event queues are cleared, and the child's instance ID is regenerated. This sequence of steps ensures that the TIAP portal sees a clean set of telemetries from the child. The exec function requires other special treatment. On exec, the following sequence of operations is performed: the original arguments to exec are preserved, the arguments to exec are changed to point to the current program (e.g., the program that is already loaded), with no command line arguments and an environment variable named DF_EXEC set to the original arguments supplied by the caller. As a result, the operating system re-executes the same program, causing the runtime to restart itself. Upon seeing DF_EXEC set, the runtime will launch the original program defined in the call to exec, with runtime protection.

Immediately after the application call is sent to block 304, the original call command is invoked at block 306. Calling the original command is necessary to allow the application to operate as intended. The operations in blocks 304, 306, 310, 312, 314, and 316 may be executed by TIAP runtime module 110 or telemetry module 112. The original call command accesses the native library at block 307. This leads to a system call at block 308, and then access to the kernel at block 309.

It should be understood the flowchart can be implemented in any process being used by a customer application product. For example, the flowchart can be implemented in a web server, a database, middleware, or any other suitable platform being used by the application. That is, the same interception library can be used in all processes. This enables a history of the stack trace to be captured and analyzed.

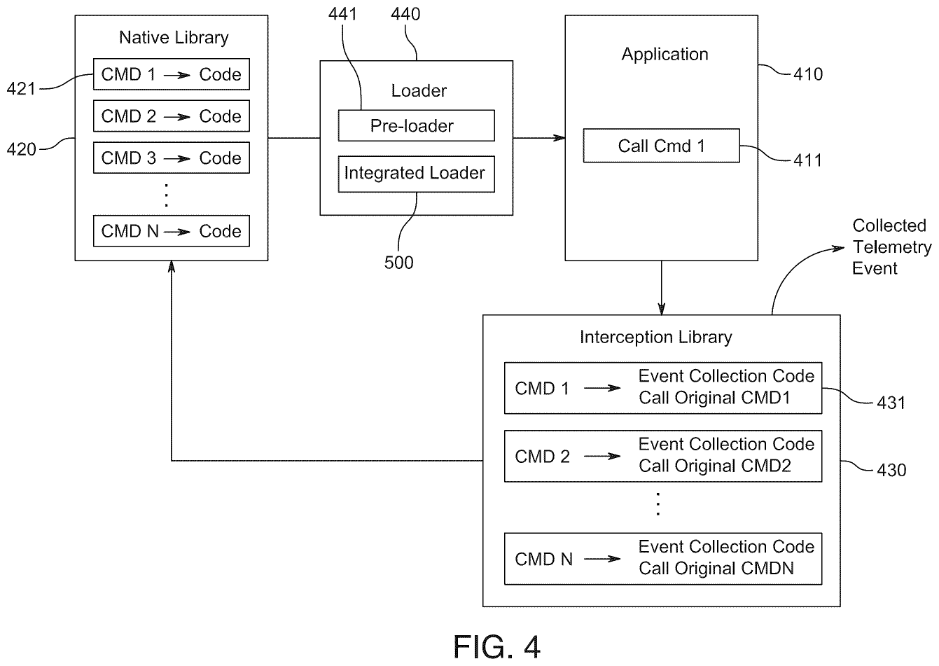

FIG. 4 shows an illustrative block diagram of how the application calls are intercepted, how event telemetry is collected, and how the application calls are executed according to an embodiment. The application is shown in block 410 and the native library associated with the application is shown in block 420. Native library 420 can include code for N number of commands, functions, or binaries (shown here as CMD1, CMD2, CMD3, and so on). Each command is associated with its own code (as shown) for implementing the command. When application 410 is running, it can call a command (e.g., call CMD1 411). FIG. 4 also shows an interception library in block 430. Interception library 430 can include a copy of each command contained in the native library. The copied commands may not contain the actual code of the native library commands but can include event collection code (or interception code) that enables telemetry associated with the application call to be collected. After the telemetry event is collected, the original command called by the application is called using a trampoline function. The interception code can include the trampoline function and telemetry grammars that define what parameters to collect. For example, assume application 410 calls CMD1 411. In response to call of CMD1 411, CMD1 431 in interception library 430 is accessed, and the telemetry event associated with call CMD1 411 is collected. After the event is collected, the original CMD1 421 is called using a trampoline function and the application call of CMD 411 is executed. In a trampoline function, call CMD1 411 initially goes to interception library 430 and then trampolines to native library 420.

Loader 440 can enable application 410 to load code in a library to be executed. For example, assuming that interception library is not present and the call CMD1 411 is called. The loader would load the code 421 in native library so that the CMD1 operation could be executed. However, in the embodiment illustrated in FIG. 4, interception library 430 is present and must be the first library accessed in response to a call by application 410. One way to ensure that interception library is accessed first is to set a pre-loader (e.g., preloader 441) to interception library 430. The pre-loader is commonly referred to as LD_PRELAOD. For example, LD_PRELOAD is set to Interception Library. This results in pre-loader instructing loader 440 to access interception library 430 first before accessing any other libraries such as native library 410.

An alternative to using a preloader is to use an integrated loader (e.g., integrated loader 500) for each application. This integrated loader can eliminate a few potential issues that may exist with using the preloader. For example, a customer could turn the preloader off, which would prevent telemetry collection because the interception library would not be accessed first. Another potential issue that can arise using the preloader is that other resources may use it, thereby potentially causing who goes first management issues. In addition, if an application uses static linking (e.g., where code in the native library is copied over to the application), the pre-loader will not work.

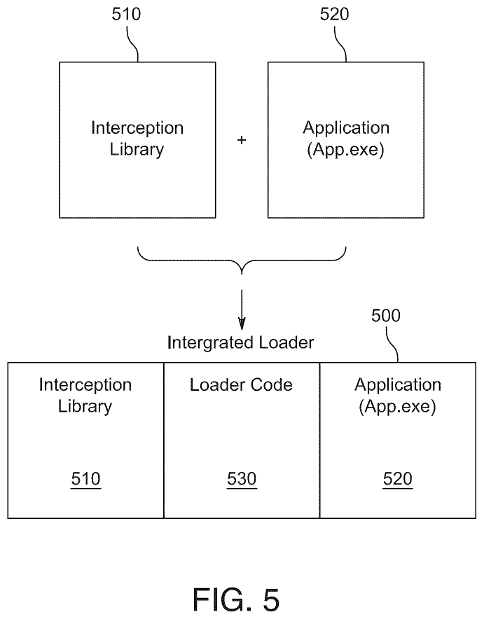

FIG. 5 shows an illustrative block diagram of an integrated loader according to an embodiment. Integrated loader 500 can be a combination of an interception library 510, an application 520, and loader code 530. When integrated loader is run, interception library 510 is first accessed, and then loader 530 is accessed to load application 520 without requiring any external dependencies. When integrated loader 500 is used, the same flow as described above in connection with FIG. 4 is used. That is, when the application makes a call, that call is intercepted by the interception library (and event telemetry is collected) and the original call is executed. Integrated loader 500 can be a custom built loader that does in-place trampolining based on IAT (import address table)/GOT (Global Object Table)/PLT (Procedure Linking Table) fixups. In some embodiments where static binaries are used, integrated loader 500 can execute hunt-and-replace fixups for static binaries as opposed to using load-time fixups.

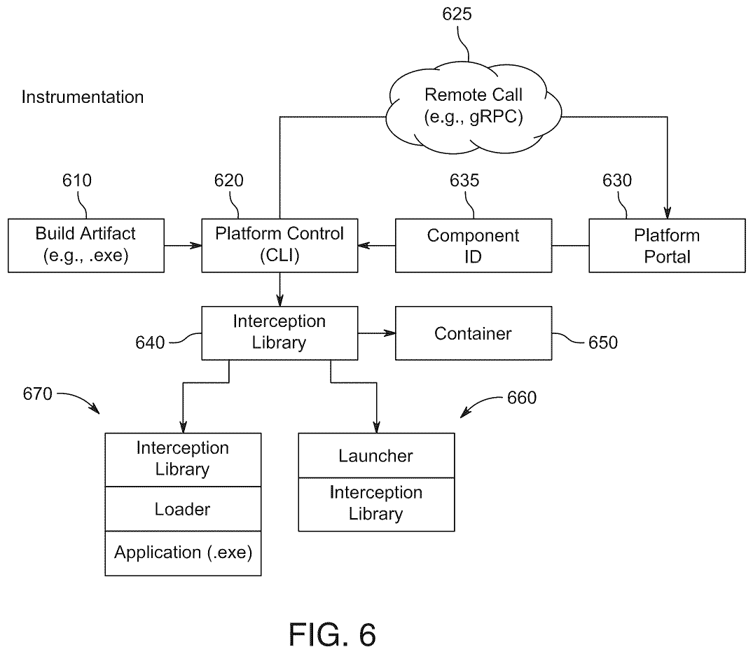

FIG. 6 shows an illustrative block diagram of an instrumentation module or system loading module according to an embodiment. A process called system loading or instrumentation is performed to merge a customer application (i.e., application executable) with the TIAP to produce a new “system loaded” build output. The result is executable code unique to the customer. System loading combines the TIAP runtime (e.g., interception library), the customer build artifact (i.e., customer application), an optional loader, and an optional security policy, and outputs a new binary that is a drop-in replacement for the original customer build output. The replacement executable code is used to provide telemetry collection and optionally, policy enforcement. Customers may also optionally load parts of their application that are not self-built (e.g., system loading a database engine or web server binary is possible). FIG. 6 shows build artifact (e.g., a component binary or the application executable) in block 610, a command line interface in block 620, remote call in block 625, the TIAP portal in block 630, component ID in block 635, interception library in block 640, a container in block 650, a launcher in block 660, and integrated loader in block 670.

The system loader is a program that is built on the TIAP and downloaded by a user to their workstation or build infrastructure machine. The system loader is typically part of a command line interface tool. In some embodiments, command line interface (CLI) tool 620 can be custom built for each customer as it will load components for that customer only. In other embodiments, CLI tool 620 is generic tool provided to each customer that enables the customer to build a different interception library for each application. The TIAP 630 can create the custom CLI tool (containing the system loading function) by using a link kit installed in the portal. The link kit includes a set of object files (.o files) that are linked against a customer-specific object file built on demand (from a dynamic code generation backend placing various statements into a .c file and compiling to an object file). This produces a customer specific CLI tool that contains all information required to produce a binary keyed to the customer that downloaded the CLI tool. This per-customer approach to CLI tool generation eliminates the need for the customer/user to enter many tenant-specific details when loading components. The CLI tool may also contain any SSL certificates or other items required for a secure transaction with the management portal. In other approaches, the SSL certificates can be obtained from an “API token,” which substitutes embedding the SSL certificate into CLI tool 620.

The CLI tool can provide several functions: loading, showing/managing applications and components, showing telemetry events, showing audit logs, and showing alerts and metrics. At a high level, the CLI tool offers a command line interface to much of the same functionality offered by the web UI provided by the TIAP portal.

During system loading, CLI 620 can receive build artifact 610 and generate interception library 640 by developing interception code for each component in the build artifact 610. The interception code can include telemetry grammars that define which events should be monitored for and recorded. The interception code can also include a trampoline function that transfers the application call to the native library so that the original call by the application is executed as intended. That is for each component of an application, application executable, or build artifact, a TIAP based interception code is generated and included in interception library 640. For example, if the first command code is being processed, CLI 620 can send that first command to platform portal 630 via remote call 625. Portal 630 can assign that command a component ID 635 and pass it back down to CLI 620. This way when telemetry events are collected, the component ID will match with the component ID assigned by portal 630. CLI 620 can populate interception library 640 with each component of build artifact 610. When the interception library is complete, CLI 620 can provide the output to container 650, launcher 660, or integrated loader 670. Container 650 can be a class, a data structure, or an abstract data type whose instances are collections of other objects. Launcher 660 is akin to the preloader concept discussed above in connection with FIG. 4. Loader 670 is akin the integrated loader concept discussed above in connection with FIG. 5.

Protection of non-executable artifacts is also possible. To protect interpreted scripts or languages, the system loader can provide a special launcher mode that produces a special binary containing only the TIAP runtime. When using launcher mode, the special binary executes a command of the customer's choice, as if the command being executed was already contained within the output. This allows for scenarios where interpreted languages are used and it is not determinable which interpreter may be present in the target (deployment) machine (as such interpreters may vary between the build environment and the deployment environment).

The CLI tool has various subcommands that are specified on the command line, such as ‘load’, ‘applications’, ‘components’, etc. The load subcommand can run in one of two modes: default and launcher. Each mode produces a different type of output file. In the default mode, which produces an integrated launcher of FIG. 5, the tool takes an input file (a binary file typically produced by the customer's build system or sourced from a trusted ISV), and produces an output file containing TIAP runtime code, customer application executable code (e.g., customer binary), certificates, digital signatures, and telemetry grammar. The CLI tool can contain TIAP runtime code for many different architectures (e.g., amd64, i386, arm32, aarch64, etc.). The specific runtime to choose is determined by the architecture of the customer binary. Certificates can include other identity material for later use in secure communication with the TIAP during execution. The digital signature may be used to avoid tampering (on platforms which support this feature). The Component ID is assigned by the TIAP during the system loading operation and is part of the loaded output. As stated previously, the TIAP runtime is capable of collecting arbitrary telemetry events. The TIAP runtime inserts trampolines into a component based on a set of telemetry grammars that describe which APIs/functions to interpose on. A telemetry grammar can include a code module name (which is name of a native library or other executable code that the API of interest is associated), a function name (which is the name of the function to intercept), and parameter grammars (which can include none or one or more of the following: parameter number (which can include the ordinal position of the parameter (C calling convention (“left-to-right”))), parameter type (which is the data type of this parameter), and parameter size, which is the size of the data, if not known from its type)).

A list of telemetry grammars is built into the loaded component. This occurs at application registration time (e.g., during system loading, when the component and application are being registered with the TIAP). The TIAP can provide a preconfigured set of interesting/well-known telemetry grammars that are automatically available as part of this transaction. Customers can override, customize, or remove any of these grammars using a user interface in a TIAP management portal (or the CLI tool). Customers can also define their own telemetry grammars, if they wish to collect additional telemetries not present in the TIAP common set.

The default set of telemetry grammars is stored in the TIAP's configuration database, and cloned/copied for each customer as they register with TIAP; this allows the customer to make any customizations to the default set they wish, if desired. Each set of customer-specific telemetry grammars are stored with the customer data in the configuration database (albeit separate from the default set or other customers' sets).

In launcher mode, the input is not specified using the -i argument, but rather with a -I (capital I). Launcher mode may be akin to the pre-loader of FIG. 4. This flag indicates that the subsequent command line parameter (after the -I) is to be interpreted as a command line that the runtime will launch. In launcher mode, the customer binary is not embedded with the output.

Rather, the system loading process outputs the TIAP runtime code, the component ID, certificates, digital signature, command line, and telemetry grammar. The specific runtime to choose is determined by the -a command line flag. In launcher mode, the TIAP will execute the command specified, and attach itself to the launched process subsequently. Launcher mode is intended for use in scenarios where the customer is reluctant to bundle the runtime code with a 3rd party interpreter (Java, Python, etc.).

If the system loader is being run in default mode and a non-executable file is specified as an input, the system loader will abort and recommend launcher mode instead. If the system loader registers a component that already exists in the TIAP, the system loader will abort and inform the user of this.

During component registration, a set of telemetry grammars will be sent to the system loader from the TIAP. These telemetry grammars contain a list of the libraries and APIs that should be intercepted for this component.

Both system loading modes accept a-t argument that contains a freeform string to be interpreted by the platform as the build time tag. This will typically be a comma separated set of key value pairs that the customer can use to assign any metadata to this component. Note that build time tags are included in the determination of any duplicate components.

The TIAP runtime is executable code that runs at process launch. It is built as position-independent code (PIC) and/or position-independent executable (PIE), and self-relocates to a random virtual address immediately upon startup. The runtime first performs a self-integrity check (to the extent possible considering the platform in use), and then performs a one-time survey/data collection of the following information: platform query, kernel version, memory, CPU (number, type, and speed), NUMA information, distribution information, and network/hardware information. The runtime then performs a transaction with the TIAP portal, sending the aforementioned data as part of a “component start” event. The TIAP portal may reply to this event by (1) proceed with start or (2) do not start. Additionally, the TIAP portal can inform the component that the host software catalogue is out of date by returning such a status code along with the component start event reply.

A host software catalogue is a list of software packages and constituent files on the machine running the component, indexed by hostname and IP address. This information is periodically gathered and uploaded to the TIAP portal to assist with analytics (specifically a common vulnerabilities and exposures (CVE) service). This catalogue is periodically updated, and the TIAP portal will report back out of date if the catalogue does not exist at all, or if the component loading date is later than the last catalogue update time, or if a set age threshold is exceeded (typically set to 1 week by default). If the TIAP portal requests a new catalogue to be uploaded, the runtime will compile the catalogue in a background thread and upload it to the portal when complete (asynchronously, low priority thread). The runtime either then starts the loaded or launched program, or, if the environment DF_EXEC is set, the value of that environment variable's content is used as the launched command line, overriding any -I (launch command) arguments.

On startup, the TIAP runtime can act as a replacement for the system run-time link-editor. The run-time link-editor (“loader”) resolves symbols from required libraries and creates the appropriate linkages. The TIAP runtime can redirect any function names specified in the trampoline grammar to itself, resulting in the creation of a trampoline. A trampoline function takes temporary control over program code flow performs the desired telemetry collection, calls the original function, and then queues an event to the event queue (if the grammar specifies that the API return value or function timing information is to be collected—otherwise the event is sent before the original function is called).

Static binaries pose a different challenge in the sense that there are typically no imports listed in the executable header. The runtime must perform a “hunt and patch” operation, in an attempt to find the corresponding system call stubs that match the function listed in the telemetry grammar. This can involve the following extra steps: searching through memory regions marked executable for system call (syscall) instructions, handling polymorphic syscall instructions (syscall opcodes buried within other instructions; false positives), handling just in time compiled (JITed) code, and handling self-modifying code. JITed and self-modifying code can be detected by mprotect(2) calls-code behaving in this way will be attempting to set the +X bit on such regions. Certain well known languages that output code using these approaches can be handled by out-of-band knowledge (such as hand inspection or clues/quirks databases).

After a customer's product has been configured to operate with the TIAP, telemetry events can be collected. These events can be communicated to the TIAP using an event API. Each “instrumented” component of the customer's application may be able to access the event API to communicate events. The communicated events may be processed by an event service running on the TIAP. The event service can be implemented as a gRPC endpoint running on a server responsible for the component. When the TIAP runtime detects an event of interest, a gRPC method invocation is invoked on the event service. The TIAP runtime knows the server (and consequently, event service) it will communicate with as this information is hardcoded into the runtime during initial loading of that component. Certain common events may occur often (e.g., opening the same file multiple times). In this case, the component may submit a “duplicate event” message which refers to a previous event instead of a completely new event message. This reduces traffic to the server.

The telemetry grammars runtime can define a telemetry level for each component or component instance. The telemetry levels can be set to one of many different levels (e.g., four different levels). Telemetry levels govern the quantity of events and data sent from the instance to the event service in the TIAP portal. Several different telemetry levels are now discussed. One telemetry level may be a zero or none level that enables the runtime to perform as a passthrough and sends only component start and exit events. Another level may be a minimal level in which the runtime sends only component start events, component exit events, metadata events, and minimal telemetry events. In this level, the runtime only communicates basic information such as the number of file or network operations/etc. Yet another level may be a standard level in which the runtime sends every type of event defined for the minimal level, plus events containing telemetry about the names of files being opened and lists of 5-tuple network connection information. In this level, file events will contain only a file name plus a count indicating the number of times that file was opened. Similarly, this level conveys the list of 5-tuples and a count of how many times that 5-tuple was seen. The standard level also sends event telemetry for the count of each 3rd party API used (count and type). Yet another level is the full level in which the runtime sends all events, including a separate event for each file and network access containing more information about the access, a separate event for each API access, etc. The full telemetry model may buffer events in the instance's filesystem locally before uploading many events in bulk (to conserve network bandwidth).

The telemetry levels can be configured in a variety of different ways. A default telemetry level can be set when the application or component is loaded. If desired any default telemetry level can be overridden at runtime by a runtime tag. The telemetry level can be set by an administrator using the TIAP portal. The administrator can override either of the above settings using a per-instance/component group/application/dashboard setting for the desired telemetry level. Telemetry levels are communicated back to the component multiplexed with the return status code for any event.

The telemetry events can be configured to adhere to a specific message structure. The message structure may be required to interface with the protocol buffers or Interface Definition Language (IDL) used by the event service. Each event can include two parts: an event envelope and an event body. The event envelope can include a header that contains information about the classification/type of the event, and information about the runtime that generated the event. The event body can include a structure containing the event information. This structure is uniquely formatted for each different type of event.

The event envelope can include several different fields. Seven fields are shown in the example pseudocode above. One field is the component_id field. This field includes the universally unique identifier (UUID) of the component making the event submission. This ID is created during system loader and remains constant for the lifetime of the component. Note that there can be multiple component instances with the same component ID. Another field is the event_id field. This is the UUID of the event being submitted. This ID is selected randomly at event creation time. Event IDs can be reused by setting a ‘duplicate’ flag. Another field is the uint64 timestamp field which represents of the number of seconds since the start of a component instance (e.g., standard UNIX time_t format) when the event occurred. Yet another field is the timestamp_us-uint64_t which is a representation of the number of microseconds in the current second since the start of the component instance (e.g., standard UNIX time_t format) when the event occurred. Another field is the duplicate field which is set to true to indicate this event is a duplicate of a previously submitted event, and varies only in timestamp. A build_tag field contains the build time tag assigned to the component submitting the event, if any. A runtime_tag field contains the runtime (environment variable sourced) tag assigned to the component instance submitting the event, if any.

If the duplicate field is set to 1, this indicates that the event with the supplied event_id has occurred again. In this scenario, the event service will ignore any other submitted values in the rest of the message, except for the updated/new timestamp values.

Many different types of telemetry events can be collected. Each of these event types can be processed by the event service running on the TIAP. Several event types are now discussed. One event type is a component start event, which is sent when the component starts. This event includes information about the component, runtime, host platform and library versions, and other environmental data. Component start events are sent after the runtime has completed its consistency checks and surveyed the host machine for infrastructure-related information.

The IDL shown above describes two enumerations used in this event type: architecture_type and OS. Architecture type is enumerated by a value indicating the platform of the runtime making the event submission. The OS is enumerated by a value indicating the operating system of the runtime making the event submission. The version and os_type fields are freeform strings. For example, on a Windows host, version might be set to “Windows Server 2019”. On a Linux host, version might be set to “5.2” (indicating the kernel version). The os_type on a Linux host might be sourced from the content of lsb_release and might contain “Ubuntu 18.04”, for example. The runtime will calculate the amount of time spent during component startup and report this in the start_time and start_time_us fields. This time represents the overhead induced by the platform during launch.

Another type of event is a component exit event. A component exit event is sent when the component exits (terminates). Component exit events are sent if the component calls exit(3) or abort(3), and may also be sent during other abnormal exit conditions (if these conditions are visible to the runtime). Component exit events have no event parameters or data other than the event envelope.

Another event type is a file event. A file event is sent when various file operations (e.g., open/close/read/write) occur. These are sent for individual operations, when the runtime is in maximum telemetry collection mode. No events are sent on other file operations. File open operations are used to discern component file I/O intent-based on the O_xxx flags to open(2), events may or may not be sent. Exec operations, while not specifically based on open(2), can be sent for components that call exec(3) using a process event.y.

Yet another event type is a bulk file event. A bulk file event can be sent periodically when the runtime is in minimal telemetry collection mode or higher. It can contain a list of files opened plus the count of each open (e.g., “opened/etc/passwd 10 times”). Multiple files can be contained in a bulk file event.

Network events are yet another event type. Network events can be sent when various network operations (e.g., listen/accept/bind) occur. These are sent for individual operations, when the runtime is in maximum telemetry collection mode. Network events can be sent under the following conditions: inbound connections and outbound connections. An inbound connection event can be sent when the component issues a system call (e.g., the bind(2) system call). Outbound Connections—An outbound connection event can be sent when the component issues a connect system call (e.g., connect(2) system call).

The runtime will fill a NetworkEventBody message with the fields defined above. Protocol numbers are taken from a socket system call (e.g., socket(2) system call) and defined in various protocols. The TIAP portal or command line interface is responsible for converting the protocol numbers to readable strings. Address family information is also taken from a system call (e.g., system(2) call) and correspond to AF_* values from socket.h. The local_address and remote_address fields contain up to 16 bytes of local and remote address information (to accommodate large address types such as IPv6). If shorter address sizes are used, the unused bytes are undefined. It should be noted that all fields are populated on a best-effort basis. In certain circumstances, it is not possible for the runtime to detect some of the parameters required. In this case, the runtime will not supply any value for that field (and the field will default to protobuf's default value for that field type).

Bulk network events are yet another type of telemetry events. Bulk network events can be sent periodically when the runtime is in minimal telemetry collection mode or higher. These events can contain a list of 5-tuple network connection events (e.g., connect from local 1.2.3.4:50 TCP to 4.5.6.7:80). Multiple 5-tuple network connection events can be contained in a bulk network event.

Network change events are another example of telemetry events. Network change evens can be sent when an IP address on the machine changes. This event is also sent by the runtime during component start to let the management portal know which IP addresses the system is currently using. Network change events are sent by the runtime when an network change has been detected on the host. This is a periodic/best-effort message and these events may not be delivered immediately upon network state change. Network changes can include addition or removal of an interface, addition or removal of an IP address to an existing interface, or an alteration of a network's media type. A network change event summarizes the current state of all interfaces on the host. This simplifies the logic required by the API and analytics service as only the latest network change event needs to be examined in order to determine the current state, with the slight drawback of having to re-send information for unchanged interfaces.

Memory events are another example of telemetry events. Memory events can be sent when various memory operations (e.g., mprotect/mmap with unsafe permissions) occur. Memory events can be sent when a component attempts to assign an invalid permission to a region of memory. For example, the event may be sent when attempting to set writable and executable memory simultaneously or attempting to set writable permission on code pages. Memory events are not sent for ‘normal’ memory operations like malloc(2) or free(2). This is due to the volume of ordinary memory events that occur with great frequency during normal component operation.

Depending on the type of memory event, the runtime may or may not be able to compute values for all the fields described above. In this case, the default protobuf values for those data types can be used.

Process events are another example of telemetry type. Process events can be sent when process related operations such as fork/exec or library loads occur. The runtime sends a process event when any of the following occur: the process forks using a fork call (e.g., fork(2)), the process executes using any of the exec*(2) or posix_spawn(2) system calls, or the process loads a new library using a open system call (e.g., dlopen(2)). A process event contains an identifier corresponding to the type of event that occurred, with additional information for execute and library load events.

The info field contains value data if event_type is ExecEvent or LibraryEvent. It is undefined for ForkEvent style process events. The info field contains the name of the executed process plus command line parameters for ExecEvent events, and the fully qualified pathname for LibraryEvent events.

Metadata events are another example of a telemetry type. Metadata events can be sent at periodic intervals to update the management portal with information about memory and CPU usage. Metadata events are periodic events sent from the runtime that contain metrics that are counted by the runtime but that might not necessarily result in alerts being generated. Generally, metadata events are events that contain data that do not fit into other event categories. These metrics can include current process memory usage, current OS-reported CPU usage, number of signals received by the process, TIPA runtime overhead (CPU/memory), and total number of events sent to the event service.

It should be understood that the foregoing IDL definitions are not exhaustive and that other event IDL definitions are possible based on telemetry gathered using embodiments discussed herein.

Third party API usage events are another telemetry type and can be sent when the component makes use of a monitored third party API (e.g., typically CSP-provided APIs, like S3, RDS, etc.).

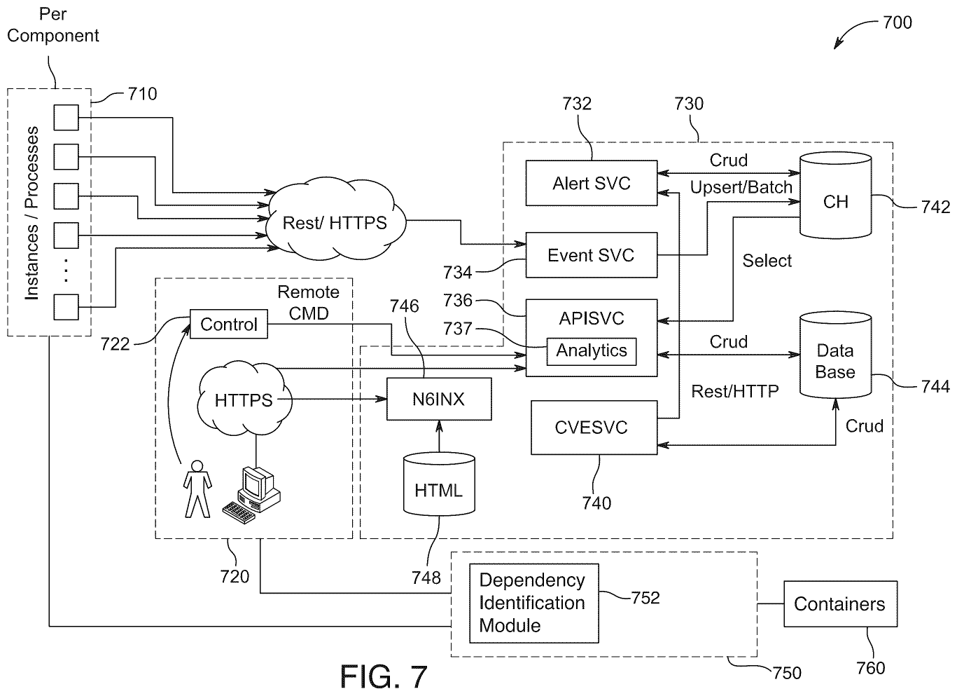

FIG. 7 shows an illustrative block diagram of TIAP 700 according to an embodiment. In particular, FIG. 7 shows instances of one or more components 710 associated with a customer application being run and sending telemetry events, a user interface 720 for interfacing with the TIAP, and backend portion of the TIAP portal 730. The dashed line box 710 can represent one component associated with an application that has a component configured to communicate telemetry events to TIAP portal 730. Each box within dashed line box may represent specific instances or processes for that component. It should be understood that multiple components are typically associated with an application, but only one is shown to avoid overcrowding the drawing. User interface 720 can include, for example, a website based user interface that enables an administrator to access TIAP portal 730. The content of the UI can be delivered by an engine X (nginx) web server (preconfigured in the appliance image if hosted on-premise). The user can interact with a control UI 722 to send remote commands to API service 732 in TIAP portal 730. Example screen shots of different UI screens are discussed in more detail below. TIAP portal 730 can operate several different services, a click house, a postgres (PG), and HTML code. In particular, TIAP portal 730 can include alert service 732, event service 734, API service 736, webapp service 738, CVE service 740, clickhouse 742, databases 744, servicer software 746, and HTML database 748. CRUD represents basic functions of persistent storage, including create, read, update, and delete. REST refers to a representational state transfer that defines a set of constraints.

TIAP 700 can be implemented as a multitenant SaaS service. This service contains all the TIAP platform software components. It is anticipated that some customers may desire to host parts or all of the SaaS portal in their own datacentre. To that end, a single-tenant version of the TIAP portal services can be made available as appliance virtual machine images. For example, the appliance image can be an .OVF file for deployment on a local hypervisor (for example, VMware vSphere, Microsoft Hyper-V, or equivalent), or as an Amazon Web Service Amazon Machine Image (AMI). The appliance images are periodically updated and each deployed appliance can optionally be configured to periodically check for updated appliance code.

API service 736 can implement a core set of APIs used by consumers of TIAP 700. For example, API service may enable user interface 722, a command line application tool, or any customer-written applications that interface with TIAP 700. In some embodiments, API service 736 may function as an API server. API service 736 can be in Node.js using a Sail JS MVC framework. Services provided by API service 736 can be implemented as REST APIs and manage many different types of entities stored in an event database (e.g., clickhouse 742). One such entity can include applications, where service 736 retrieves application information from a primary DB (database 744) based on various parameters (application name, for example). Another entity can be components in which server 736 retrieves component group information from the primary DB (database 744) based on various parameters (component ID, for example). Yet another entity can include instances in which service 736 retrieves instance information from the primary DB (database 744) based on various parameters (component ID and hostname, for example). Another entity can include events in which service 736 retrieves event information from the Events DB (ClickHouse 742) based on various parameters (component or application ID plus event type, for example).

API service 736 can also provide REST APIs to manage alert and insight entities stored in an analytics database (not shown). An alert entity API can retrieve alerts that have been deposited by analytics service 737 into an analytics database (not shown). An insight API can retrieve insights (analysis items) that have been generated by analytics service 737.

API service 736 can also provide REST APIs to manage the entities stored in a CVE database. A CVE API can produce a list of CVEs of components that are vulnerable.

API service 736 can provide provides REST APIs to manage the entities stored in a user database. A users API can provide user accounts, including saved thresholds and filters, and other UI settings. A role API can provide group roles, including role permissions.

REST calls to API service 736 can require an API key. API keys are JWTs (JSON Web Tokens) that grant access to the bearer for a particular amount of time. JWTs generated by the API keys are assigned by the authentication service during logon (for the browser/UI based application) and can also be manually created for use with the CLI (users may do this in ‘Account Settings’ in the UI). If desired, the generation of the JWTs can be performed elsewhere as is known in the art. In addition to the UI and the CLI tool, customers may develop their own applications that interface with the platform. In these scenarios, a “push” or “callback” model is used with the customer's API client (e.g., the application the customer is developing). API service 736 allows for a customer-supplied REST endpoint URL to be registered, along with a filter describing which events the customer's application has interest in. When events of these types are generated, the API server will make a REST PUT request to the customer's endpoint with the event data matching the filter supplied. To safeguard against misconfiguration or slow endpoints causing a potential DoS, successive failures or slow callbacks will result in the callback being removed from the API server, and a log message will be generated in the system log. The API server will also rate limit registration requests. API clients written in this fashion may de-register at any time using the same URL they registered with using the API server's de-registration API. Any registered API client may also be de-registered in the UI or via the CLI tool.

Event Service 734 collects event telemetry from components 710. As explained above, each component has been instrumented to supply telemetry event information to TIAP 700. Upon receiving an event (or multiple events), event service 734 converts the event body into a record that is placed into the Events DB on the ClickHouse 742. Event service 734 can receive events via the Internet.

Analytics Service 737 can periodically survey the events collected by event service 734 and stored in the Events DB and attempts to gather insights based on the events that have been collected. Analytics service 737 is responsible for producing all alerts in the platform, as well as any suggested/remedial corrective tasks. Analytics service 737 gathers events and performs analysis on a continual basis. Analytics service 737 can apply grammars to the collected events to determine whether an alert should be generated. Analytics service 737 can also apply various machine learning models to determine if a pattern of events is detected, and whether this pattern should be alerted. Any insight or alerts that are generated can be stored as a record in the analytics DB (e.g., Postgres 744). The analytics DB is queried by API service 736 when determining if an alert or insight is to be rendered to clients.

CVE Service 740 identifies which CVEs the components have known vulnerabilities. CVE service 740 can include CVEs that are created and maintained by TIAP 700.

CVE service 740 can use a CVE database, which can be populated from a CVE pack. For example, the CVE database may include a snapshot or copy of various CVE databases that is updated on demand or at regular intervals. CVE service 740 can retrieve a list of CVEs from the CVE database. CVE service 740 periodically scans the event database and determines if any components are vulnerable to CVE. The CVE packs (database dumps) can be created manually by staff operating TIAP 700. This is a manual effort since CVE information is not released/published in a fashion that can be automatically queried. CVE susceptibility can be displayed in a UI hierarchy (e.g., CVE susceptibility is shown based on whatever view is currently active in the UI).

A housekeeping service (not shown) periodically performs cleanup of old data that is no longer required, including audit log data (after archival has been performed or at customer request), old telemetry events (retention time is per-customer specific), old alerts/insights (retention time is per-customer specific), and user accounts that have expired from any linked directory services.

TIAP 700 can maintain several databases in databases 744. An event database can contain all the telemetry received from all loaded applications/components, for all customers. The data in the events database is deposited by the event service and queried by the analytics, CVE, API, and blueprinting services. An insights/alerts database can contain all alerts and insights discovered by the analytics service, as it periodically analyzes data in the events database. Insights/alerts are deposited into the database along with information identifying which component instance (or application) the alert/insight pertains to. An audit log database contains a record of all platform actions performed by a user, for all users in a customer. These entries are generated by the API service as auditable events (changes, etc.) are made using any API offered by the API service. This also includes login/log out events and user profile related events (password changes, etc.). A user database contains information about local users defined for a tenant that are known to the platform. The user database also stores API tokens generated by users that are used by the API service for authentication. A configuration database stores any per-customer configuration information not previously described. This includes any information relating to third party integrations. The configuration database also stores portal-wide configuration used by TIAP systems administrators/operations teams.

TIAP 700 can provide a container thinning platform for enabling a user to define criteria for identifying dependencies that can be removed from a bloated container. For example, the user can use user interface 720 to cause thinning module 750 to operate according to embodiments discussed herein. The user preferences or filters can be implemented by dependency identification module 752, which can examine containers 760 to identify dependencies that can be removed therefrom as the containers are passed through to instances/processes 710 of the application. In some embodiments, dependency identification module 752 can identify one or more dependencies that have an issue (e.g., do not meet security requirements or have an expired credential) but cannot be removed because those one or more dependencies are essential to operation of the application. In this embodiment, the user can be notified that the application is using one or more compromised dependencies. In furtherance of this embodiment, the TIAP can recommend functionally equivalent dependencies that are not compromised and that can be used in lieu of the one or more compromised dependencies.

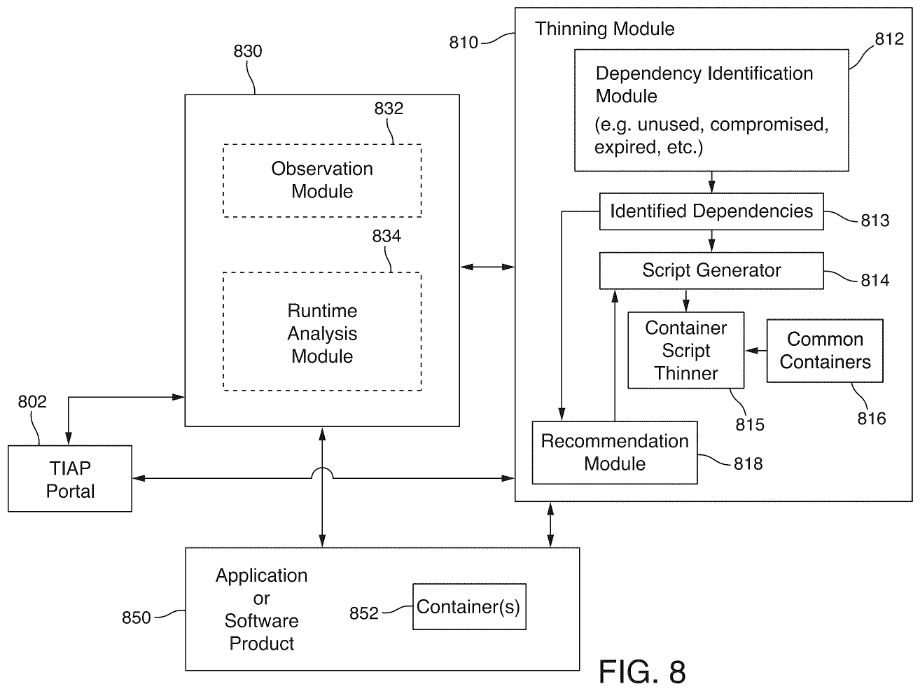

FIG. 8 shows an illustrative block diagram of a thinning module 810 in connection with an application or software product 830 being observed or analyzed by observation or runtime analytics software 850. Application or software product 830 may represent the software being analyzed or observed by observation module 832 or runtime analysis module 834 and includes one or more containers 852 that are processed/monitored by intelligent webhook 810. In some embodiments, observation or runtime analytics software 850 may be a TIAP, as described above, that instruments the application so that the TIAP can observe operations of the application and obtain analytics thereof. Application or software product 850 can include one or more containers 852 that are necessary for operation of the application. Image copies of containers 852 can be provided to thinning module 810. Thinning module 810 can include dependency identification module 812, which may identify dependencies that can be removed from a particular container. Dependency identification module 812 can apply filters to a container to identify dependencies that can be removed. For example, one filter may identify dependencies that are not used by the application. Another filter may identify dependencies that have expired (e.g., their certificates or authorization tokens have expired). Yet another filter may identify dependencies that are known to be compromised. In one embodiment, module 812 can obtain a first list including all components used by the application and a second list of all components existing in the container image. A differential can be obtained between the first and second lists to determine which components should be removed from the container image. This differential can be provided as identified dependencies 813.

In some embodiments, even if one or more of the identified dependencies may be flagged for removal, such flagged dependencies may be deemed critical to the operation of the application and cannot be removed. Such flagged identified dependencies may be referred to as a flagged dependency with non-removal status.

Identified dependencies 813 can be provided to script generator 814, which can generate a script 815 that removes the identified dependencies from the container when the script is executed. In some embodiments, the container may be shared with common containers 816 across an organization (e.g., for different applications and/or products). When the container is part of a commonly shared container, script 815 may remove the identified dependencies from each of the commonly shared containers.

Identified dependencies 813 may also be provided to recommendation module 818. In one embodiment, recommendation module 818 can determine the composition of the thinned container based on an assumption that the identified dependencies are or will be removed from the container. The thinned container can be compared to a library of commercially available containers. The comparison can ascertain whether the functionality of the thinned container is equivalent to any one of the commercial containers. As another example, the comparison can determine how much commonality exists between the thinned container and any one of the commercial containers (e.g., how many of the dependencies are the same). If a minimum threshold of commonality is established between the thinned container and a given commercial container, that commercial container may replace the thinned container. If the thinned container can be replaced with one or more of the commercially available containers, recommendation module 812 can recommend the one or more commercially available containers to a user. For example, the recommendation may be provided in a user interface of the TIAP.

In another embodiment, recommendation module 818 can receive identified dependencies 813 that are flagged dependencies with non-removal status. Such identified dependencies cannot be removed without a suitable replacement. Recommendation module 818 may also be able to find suitable replacement for one or more of the flagged dependencies with non-removal status. The replacement can be functionally equivalent to the flagged dependency but complies with suitability criteria (e.g., does not have an associated CVE or expired certificate). The recommendations can be provided to a user of the TIAP as a notification in a user interface. For example, in a thinning UI window, a list of flagged dependencies can be displayed along with suitable replacements. The user may be presented with the opportunity to select which recommended dependency is to be used to replace the flagged dependency. Upon user selection, the recommended dependency can be added to scrip generator 814 that includes the recommended dependency to replace the flagged dependency. In another approach, recommendation module 118 may automatically replace the flagged dependency with the recommended dependency causing script generator 814 to incorporate the change.

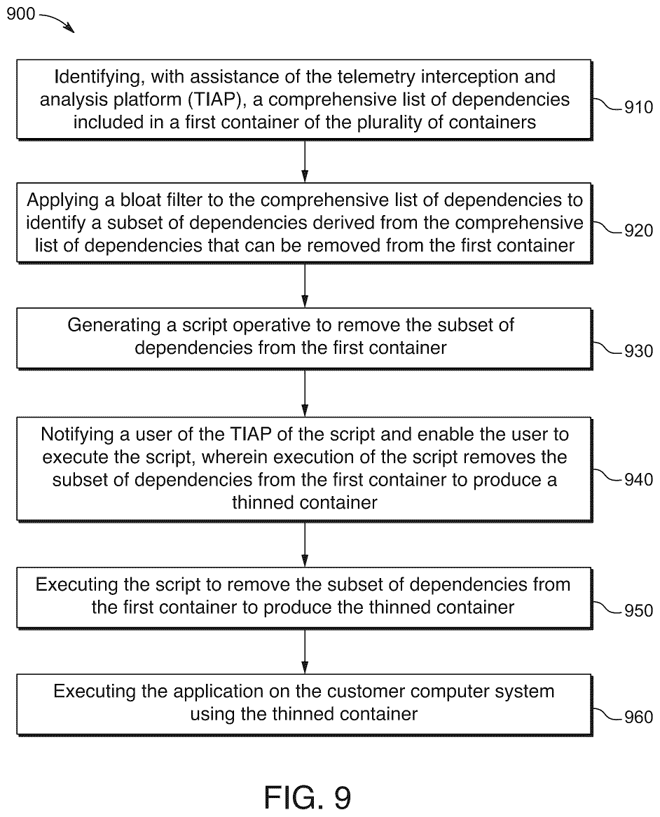

FIG. 9 shows an illustrative process 900 for thinning a container according to an embodiment. Process 900 can start at step 910 by identifying, with assistance of the TIAP, a comprehensive list of dependencies included in a first container of the plurality of containers. The TIAP has knowledge of how each container is built. At step 920, process 900 can apply a bloat filter to the comprehensive list of dependencies to identify a subset of dependencies derived from the comprehensive list of dependencies that can be removed from the first container. The bloat filter can identify dependencies that are not used by the application, identifies dependencies that have expired certificates of authenticity, identifies dependencies that are associated with common vulnerabilities and exposures, or any combination thereof. In addition, the bloat filter can identify dependencies that have an issue (e.g., exposed to a CVE) but are flagged as essential to the operation of the application. At step 930, process 900 can generate a script operative to remove the subset of dependencies from the first container and notify a user of the TIAP of the script and enable the user to execute the script, at step 940. In some embodiments, the script can include replacement dependencies to replace one or more flagged dependencies. At step 950, execution of the script removes the subset of dependencies from the first container to produce a thinned container. In some embodiments, execution of the script replaces flagged dependencies with recommended replacements thereof to produce a thinned container with replaced dependencies. If desired, at step 960, the application can be executed on the customer computer system using the thinned container or the thinned container with replaced dependencies.

It should be understood that the steps shown in FIG. 9 are illustrative and that additional steps can be added, omitted, or rearranged in order of presentation. For example, additional steps may be added to apply container thinning across commonly used containers. As another example, steps may be added to recommend a commercially available container(s) that can be used in lieu of the thinned container.

In some embodiments, a data processing system may be provided to include a processor to execute instructions, and a memory coupled with the processor to store instructions that, when executed by the processor, may cause the processor to perform operations to generate an API that may allow an API-calling component to perform at least some of the operations of one or more of the processes described with respect to one or more of FIGS. 1-9. In some other embodiments, a data processing system may be provided to include a memory to store program code, and a processor to execute the program code to generate an API that may include one or more modules for performing at least some of the operations of one or more of the processes described with respect to one or more of FIGS. 1-9. In yet some other embodiments, a machine-readable storage medium may be provided that provides instructions that, when executed by a processor, cause the processor to generate an API that allows an API-implementing component to perform at least some of the operations of one or more of the processes described with respect to one or more of FIGS. 1-9. In yet some other embodiments, a data processing system may be provided to include an API-implementing component, and an API to interface the API-implementing component with an API-calling component, wherein the API may include one or more modules or means for performing at least some of the operations of one or more of the processes described with respect to one or more of FIGS. 1-9. In yet some other embodiments, a data processing system may be provided to include a processor to execute instructions, and a memory coupled with the processor to store instructions that, when executed by the processor, cause the processor to perform operations to generate an API-implementing component that implements an API, wherein the API exposes one or more functions to an API-calling component, and wherein the API may include one or more functions to perform at least some of the operations of one or more of the processes described with respect to one or more of FIGS. 1-9. In yet some other embodiments, a data processing system may be provided to include a processor to execute instructions, and a memory coupled with the processor to store instructions that, when executed by the processor, cause the processor to interface a component of the data processing system with an API-calling component and to perform at least some of the operations of one or more of the processes described with respect to one or more of FIGS. 1-9. In yet some other embodiments, an apparatus may be provided to include a machine-readable storage medium that provides instructions that, when executed by a machine, cause the machine to allow an API-calling component to perform at least some of the operations of one or more of the processes described with respect to one or more of FIGS. 1-9.

Moreover, the processes described with respect to one or more of FIGS. 1-9, as well as any other aspects of the disclosure, may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and optical data storage devices. In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module of any one or more of any system, device, or server may be provided as a software construct, firmware construct, one or more hardware components, or a combination thereof, and may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of any one or more of any system device, or server are merely illustrative, and that the number, configuration, functionality, and interconnection of existing modules may be modified or omitted, additional modules may be added, and the interconnection of certain modules may be altered.

While there have been described systems, methods, and computer-readable media for enabling efficient control of a media application at a media electronic device by a user electronic device, it is to be understood that many changes may be made therein without departing from the spirit and scope of the disclosure. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A system, comprising:
a server for running a thinning module service in conjunction with a telemetry interception and analysis platform (TIAP) that instruments at least one container of a plurality of containers associated with an application being executed on a customer computer system;
wherein the thinning module service is operative to:
identify, with assistance of the TIAP, a comprehensive list of dependencies included in a first container of the plurality of containers;
apply a bloat filter to the comprehensive list of dependencies to identify a subset of dependencies derived from the comprehensive list of dependencies that can be removed from the first container;
generate a script operative to remove the subset of dependencies from the first container; and
notify a user of the TIAP of the script and enable the user to execute the script, wherein execution of the script removes the subset of dependencies from the first container to produce a thinned container.

2. The system of claim 1, wherein the TIAP is operative to:
execute the script to remove the subset of dependencies from the first container to produce the thinned container; and
execute the application on the customer computer system using the thinned container.

3. The system of claim 1, wherein the TIAP is operative to display the subset of dependencies in a user interface.

4. The system of claim 1, wherein the bloat filter identifies dependencies that are not used by the application.

5. The system of claim 1, wherein the bloat filter identifies dependencies that have expired certificates of authenticity.

6. The system of claim 1, wherein the bloat filter identifies dependencies that are associated with common vulnerabilities and exposures.

7. The system of claim 1, wherein the thinning module service is further operative to:
determine that the first container is commonly used by the application and a plurality of other applications, wherein the application uses a first container image and each of the plurality of other applications uses respective common container images; and
wherein the script is operative to remove the subset of dependencies from the first container image and each of the common container images to produce the thinned container images thereof.

8. The system of claim 7, wherein the TIAP is operative to execute the script to remove the subset of dependencies from the first container image and each of the common container images to produce the thinned container images thereof.

9. The system of claim 1, wherein the thinning module service is further operative to:
access a library of commercially available containers;
compare the thinned container to the library of commercially available containers to determine if any one of the commercially available containers can be used in lieu of the thinned container; and
recommend to a user, via the TIAP, at least one commercially available container to be used in lieu of the thinned container.

10. The system of claim 1, wherein the thinning module service is further operative to:
apply the bloat filter to identify at least one dependency that is flagged as being critical to operation of the application but should be removed;
recommend a replacement dependency for the at least one dependency that is flagged as being critical to operation of the application, wherein the replacement dependency is functionally similar to the flagged dependency; and
generate a script operative to replace each flagged dependency with the recommended dependency.

11. A system, comprising:
a first server comprising a first processor to run a telemetry interception and analysis platform (TIAP) comprising an event service operative to receive telemetry events from a TIAP runtime being executed on a customer computer system in conjunction with an application being executed on the customer computer system, wherein the application is associated with a plurality of containers that are potentially deployed during execution of the application, and wherein each of the plurality of containers comprises a plurality of dependencies; and
a second server comprising a second processor to run a thinning module operative to trim at least one dependency from at least one of the containers, wherein the thinning module is operative to:
identify, for a first container of the plurality of containers, a subset of dependencies derived from the plurality of dependencies that can be removed from the first container, wherein the subset of dependencies is identified through application at least one filter;
generate a script operative to remove the subset of dependencies from the first container; and
notify a user of the TIAP of the script and enable the user to execute the script, wherein execution of the script removes the subset of dependencies from the first container to produce a thinned container.

12. The system of claim 11, wherein the TIAP is operative to:
execute the script to remove the subset of dependencies from the first container to produce the thinned container; and
execute the application on the customer computer system using the thinned container.

13. The system of claim 11, wherein the at least one filter identifies dependencies that are not used by the application, identifies dependencies that have expired certificates of authenticity, identifies dependencies that are associated with common vulnerabilities and exposures, or any combination thereof.

14. The system of claim 11, wherein the thinning module service is further operative to:
determine that the first container is commonly used by the application and a plurality of other applications, wherein the application uses a first container image and each of the plurality of other applications uses respective common container images;
wherein the script is operative to remove the subset of dependencies from the first container image and each of the common container images to produce the thinned container images thereof; and
wherein the TIAP is operative to execute the script to remove the subset of dependencies from the first container image and each of the common container images to produce the thinned container images thereof.

15. The system of claim 11, wherein the thinning module service is further operative to:
access a library of commercially available containers;
compare the thinned container to the library of commercially available containers to determine if any one of the commercially available containers can be used in lieu of the thinned container; and
recommend to a user, via the TIAP, at least one commercially available container to be used in lieu of the thinned container.

16. A method for thinning bloated containers in conjunction with a telemetry interception and analysis platform (TIAP) comprising:
identifying, with assistance of the TIAP, a comprehensive list of dependencies included in a first container of the plurality of containers;
applying a bloat filter to the comprehensive list of dependencies to identify a subset of dependencies derived from the comprehensive list of dependencies that can be removed from the first container;
generating a script operative to remove the subset of dependencies from the first container; and
notifying a user of the TIAP of the script and enable the user to execute the script, wherein execution of the script removes the subset of dependencies from the first container to produce a thinned container.

17. The method of claim 16, further comprising:
executing the script to remove the subset of dependencies from the first container to produce the thinned container; and
executing the application on the customer computer system using the thinned container.

18. The method of claim 16, wherein the bloat filter identifies dependencies that are not used by the application, identifies dependencies that have expired certificates of authenticity, identifies dependencies that are associated with common vulnerabilities and exposures, or any combination thereof.

19. The method of claim 16, further comprising:
determining that the first container is commonly used by the application and a plurality of other applications, wherein the application uses a first container image and each of the plurality of other applications uses respective common container images;
removing, via the script, the subset of dependencies from the first container image and each of the common container images to produce the thinned container images thereof; and
executing the script to remove the subset of dependencies from the first container image and each of the common container images to produce the thinned container images thereof.

20. The system of claim 16, further comprising:
accessing a library of commercially available containers;
comparing the thinned container to the library of commercially available containers to determine if any one of the commercially available containers can be used in lieu of the thinned container; and
recommending to a user, via the TIAP, at least one commercially available container to be used in lieu of the thinned container.
